(19) United States
(12) Patent Application Publication
(10) Pub. No.: US 2009/0028240 A1
(43) Pub. Date: Jan. 29, 2009

(54) Encoder, Decoder, Method for Encoding/Decoding, Computer Readable Media and Computer Program Elements

(76) Inventors: Haibin Huang, Singapore (SG); Wee Boon Choo, Singapore (SG); Rongshan Yu, Singapore (SG); Xiao Lin, Singapore (SG)

Correspondence Address: CROCKETT & CROCKETT, P.C., 26020 ACERO, SUITE 200, MISSION VIEJO, CA, 92691, US

(21) Appl. No.: 11/813,645

(22) PCT Filed: Jan. 9, 2006
(86) PCT No.: PCT/SG2006/000002

§ 371 Date: Jul. 3, 2008

Related U.S. Application Data
(60) Provisional application No. 60/643,317, filed on Jan. 11, 2005.

(51) Int. Cl. H04N 7/26

(52) U.S. Cl. 375/240.12; 375/E07.147

(57) ABSTRACT

An encoder for encoding a first digital signal representative for a first channel and a second digital signal representative for a second channel is described. The encoder comprises cascaded intra-channel prediction elements for compressing the first digital signal and the second digital signal based on intra-channel correlation and an inter-channel prediction element for compressing the first digital signal and the second digital signal based on inter-channel correlation.

The invention relates to an encoder, a decoder, a method for encoding, a method for decoding, computer readable media and computer program elements.

A lossless audio coder is an audio coder that generates an encoded audio signal from an original audio signal such that a corresponding audio decoder can generate an exact copy of the original audio signal from the encoded audio signal.

In course of the MPEG-4 standardisation works, a standard for audio lossless coding (ALS) is developed. Lossless audio coders typically comprise two parts: a linear predictor which, by reducing the correlation of the audio samples contained in the original audio signal, generates a residual signal from the original audio signal and an entropy coder which encodes the residual signal to form the encoded audio signal. The more correlation the predictor is able to reduce in generating the residual signal, the more compression of the original audio signal is achieved, i.e., the higher is the compression ratio of the encoded audio signal with respect to the original audio signal.

If the original audio signal is a stereo signal, i.e., contains audio samples for a first channel and a second channel, there are both intra-channel correlation, i.e., correlation between the audio samples of the same channel, and inter-channel correlation, i.e., correlation between the audio samples of different channels.

In [1] and [2], the usage of cascaded predictors is disclosed to reduce intra-channel correlation. In [3], the problem of reducing both inter-channel and intra-channel correlation is considered by computing the optimum Wiener filter weights from inverting the correlation matrix.

An object of the invention is to provide an improved method for encoding digital audio signals comprising audio samples for more than one channels.

The object is achieved by an encoder, a decoder, a method for encoding, a method for decoding, computer programmable media and computer program elements with the features according to the independent claims.

An encoder for encoding a first digital signal representative for a first channel and a second digital signal representative for a second channel is provided, the encoder comprising a first intra-channel prediction element processing the first digital signal, thereby providing a first residual signal for the first channel and a second intra-channel prediction element processing the second digital signal, thereby providing a first residual signal for the second channel. The encoder further comprises an inter-channel prediction element processing the first residual signal for the first channel and the first residual signal for the second channel by linearly combining the first residual signal for the first channel and the first residual signal for the second channel, thereby providing a second residual signal for the first channel and a second residual signal for the second channel.

Further, a method for encoding, a decoder, a method for decoding, computer programmable media and computer program elements according to the encoder described above are provided.

Illustratively, the first digital signal and the second digital signal are processed by a predictor cascade comprising intra-channel predictor elements and a inter-channel predictor element. The intra-channel predictor elements calculate a prediction for the first digital signal and the second digital signal, respectively, based on intra-channel correlation, i.e., using only information from the respective digital signal. The inter-channel predictor element calculates a prediction for the first digital signal and the second digital signal based on inter-channel correlation, i.e., using information from both the first digital signal and the second digital signal.

In this way, a high compression of the first digital signal and the second digital signal can be achieved.

Preferred embodiments of the invention emerge from the dependent claims. The embodiments which are described in the context of the encoder are analogously valid for the method for encoding, the decoder, the method for decoding, the computer programmable media and the computer program elements.

It is preferred that the encoder further comprises a third intra-channel prediction element processing the second residual signal for the first channel, thereby providing a third residual signal for the first channel and a fourth intra-channel prediction element processing the second residual signal for the second channel, thereby providing a third residual signal for the second channel.

It is further preferred that the first intra-channel prediction element further provides a first prediction signal for the first channel, the second intra-channel prediction element further provides a first prediction signal for the second channel, the inter-channel prediction element further provides a second prediction signal for the first channel and a second prediction signal for the second channel, the third intra-channel prediction element further provides a third prediction signal for the first channel and the fourth intra-channel prediction element further provides a third prediction signal for the second channel.

It is further preferred that the encoder further comprises a first cascade of intra-channel prediction elements, wherein the first intra-channel prediction element of the first cascade of intra-channel prediction elements provides a further residual signal for the first channel and a further prediction signal for the first channel by processing the third residual signal for the first channel and each of the other intra-channel prediction elements of the first cascade of intra-channel prediction elements provides a further residual signal for the first channel and a further prediction signal for the first channel by processing the further residual signal for the first channel provided by the preceding intra-channel prediction element of the first cascade of intra-channel prediction elements.

Analogously, it is preferred that the encoder further comprises a second cascade of intra-channel prediction elements, wherein the first intra-channel prediction element of the second cascade of intra-channel prediction elements provides a further residual signal for the second channel and a further prediction signal for the second channel by processing the third residual signal for the second channel and each of the other intra-channel prediction elements of the second cascade of intra-channel prediction elements provides a further residual signal for the second channel and a further prediction signal for the second channel by processing the further residual signal for the second channel provided by the preceding intra-channel prediction element of the second cascade of intra-channel prediction elements.

Illustratively, the third residual signal for the first channel and the third residual signal for the second channel are processed by further intra-channel prediction elements, such that a higher compression is achieved by exploiting intra-channel correlation.

It is further preferred that the encoder further comprises a first linear combiner linearly combining at least two of the first residual signal for the first channel, the second residual signal for the first channel, the third residual signal for the first channel and the further residual signals for the first channel, thereby providing a final prediction signal for the first channel.

Preferably, the encoder further comprises a first substracting unit substracting the quantized final prediction signal for the first channel from the first digital signal.

It is further preferred that the first linear combiner multiplies said at least two of the first residual signal for the first channel, the second residual signal for the first channel, the third residual signal for the first channel and the further residual signals for the first channel with first linear combiner weights and adds the results to form the final prediction signal for the first channel.

Analogously, it is further preferred that the encoder further comprises a second linear combiner linearly combining at least two of the first residual signal for the second channel, the second residual signal for the second channel, the third residual signal for the second channel and the further residual signals for the second channel, thereby providing a final prediction signal for the second channel.

Preferably, the encoder further comprises a second substracting unit substracting the quantized final prediction signal for the second channel from the second digital signal.

It is further preferred that the second linear combiner multiplies said at least two of the first residual signal for the second channel, the second residual signal for the second channel, the third residual signal for the second channel and the further residual signals for the second channel with second linear combiner weights and adds the results to form the final prediction signal for the second channel.

Illustratively, the results from the intra-channel prediction and the inter-channel prediction are combined by the first linear combiner and the second linear combiner in an efficient way.

Preferably, the first linear combiner and/or the second linear combiner are adapted such that the first linear combiner weights and the second linear combiner weights, respectively, are adjusted according to the Sign-Sign LMS algorithm in course of the encoding process.

Preferably, the first intra-channel prediction element and/or the second intra-channel prediction element comprises an FIR filter unit, for example an DPCM (Differential Pulse Code Modulation) filter unit.

Preferably, the inter-channel prediction element comprises a plurality of adaptive FIR filter units, for example RLS (recursive least squares) filter units.

Illustratively, the step of linearly combining the first residual signal for the first channel and the first residual signal for the second channel is done using a plurality of adaptive FIR filters, for example RLS filters. An RLS filter is an adaptive transversal filter. The RLS algorithm is famous for its fast convergence.

It is further preferred that the third intra-channel prediction element and/or the fourth intra-channel prediction element and/or the intra-channel prediction elements of the first cascade of intra-channel prediction elements and/or the intra-channel prediction elements of the second cascade of intra-channel prediction elements comprise adaptive FIR filter units, for example NLMS (normalized least mean square) filter units.

Preferably, the first digital signal and the second digital signal are digitized audio signals.

Illustratively, the first digital signal and the second digital signal together form a stereo audio signal.

In one embodiment, the encoder is adapted to further encode a third or more digital signals representative for a third or more channels.

Illustratively, the encoder can further comprise units similar to the ones described above such that further digital signals can be encoded analogously to the first digital signal and the second digital signal such that in particular, inter channel correlation between a multiplicity of channels can be exploited to achieve compression.

Illustrative embodiments of the invention are explained below with reference to the drawings.

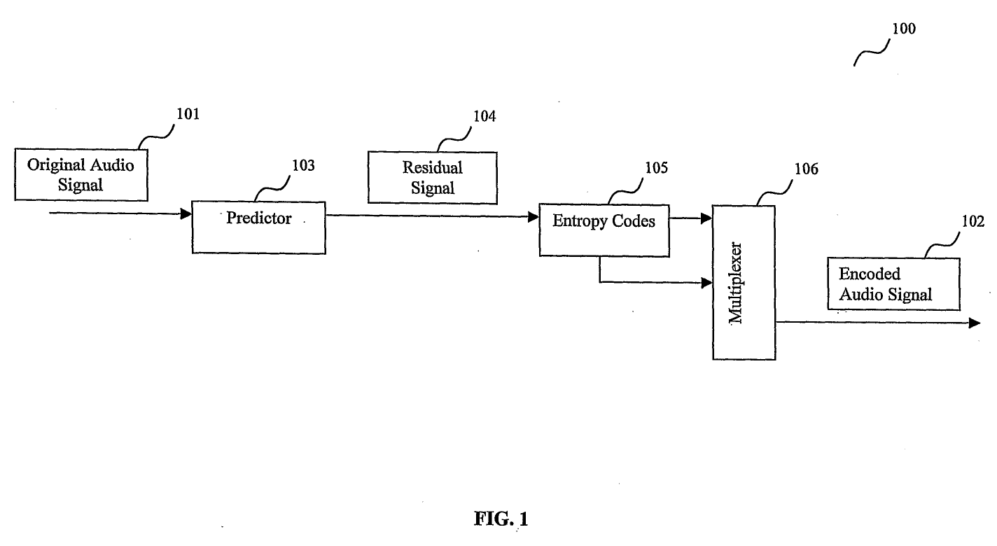

FIG. 1 shows an encoder according to an embodiment of the invention.

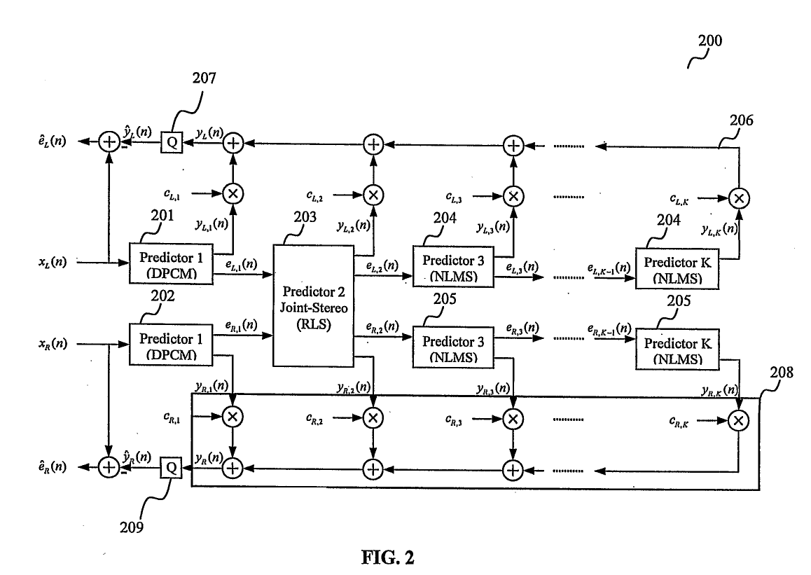

FIG. 2 shows a predictor according to an embodiment of the invention.

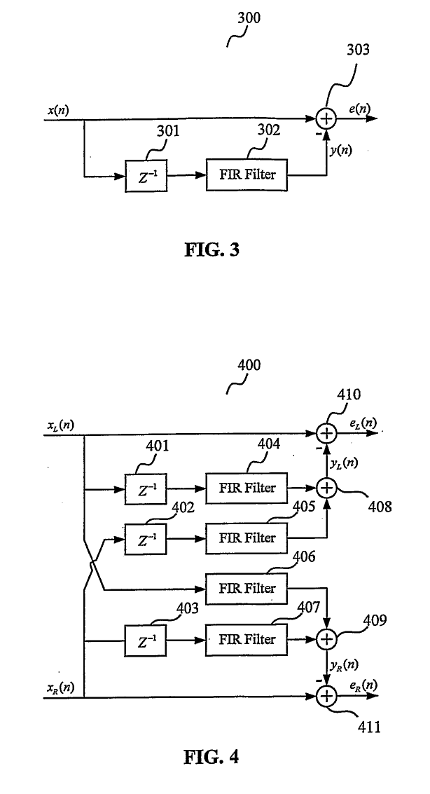

FIG. 3 shows a predictor stage according to an embodiment of the invention.

FIG. 4 shows a joint-stereo predictor according to an embodiment of the invention.

FIG. 1 shows an encoder 100 according to an embodiment of the invention

The encoder 100 receives an original audio signal 101 as input.

The original audio signal 101 is a digital audio signal and was for example generated by sampling an analogue audio signal at some sampling rate (e.g. 48 kHz, 96 KHz or 192 kHz) with some resolution per sample (e.g. 8 bit, 16 bit, 20 bit or 24 bit).

The audio signal comprises audio information, i.e. audio samples, for a first audio channel (denoted as “left” channel in the following) and for a second audio channel (denoted as “right” channel in the following).

The purpose of the encoder 100 is to encode the original audio signal 101 to generate an encoded audio signal 102 which is losslessly encoded, i.e., a decoder corresponding to the encoder 100 can reconstruct an exact copy of the original audio signal 101 from the encoded audio signal 102.

The original audio signal 101 is processed by a predictor 103 which generates a residual signal 104 from the original audio signal 101. The functionality of the predictor 103 will be explained in detail below.

The original signal 104 is then entropy coded by an entropy coder 105. The entropy coder 105 can for example perform a Rice coding or a BGMC (Block Gilbert-Moore Codes) coding.

The coded residual signal, code indices specifying the coding of the residual signal 104 performed by the entropy coder 105, and optionally other information are multiplexed by a multiplexer 106 such that the encoded audio signal 102 is formed. The encoded audio signal 102 holds the losslessly coded original audio signal 101 and the information to decode it.

In the following, the functionality of the predictor 103 is explained with reference to FIG. 2, FIG. 3 and FIG. 4.

FIG. 2 shows a predictor 200 according to an embodiment of the invention.

As mentioned above, it is assumed that the original audio signal 101 comprises audio samples for a first (left) channel and a second (right) channel. The audio samples for the left channel are denoted by x_{L}(i) and the audio samples for the right channel are denoted by x_{R}(i) (where i is an index running over all audio samples). An audio sample for the left channel x_{L}(i) corresponds to the audio sample for the right channel with the same index x_{R}(i) (in the sense that it is an audio sample meant to be played at the same time). x_{L}(i) is assumed to precede x_{R}(i) in the original audio signal 101. The original audio signal 101 can therefore be written as the audio sample stream . . . , x_{L}(i−1), x_{R}(i−1), x_{L}(i), x_{R}(i), x_{L}(i+1) x_{R}(i+1), . . . .

The audio samples for the left channel-are subsequently input to a first DPCM predictor 201. The processing of the audio samples for the left channel by the predictor 200 is explained considering as an example the nth audio sample for the left channel x_{L}(n).

Analogously, the audio samples for the right channel are subsequently input to a second DPCM predictor 202. As an example, the nth audio signal for the right channel x_{R}(n) is considered.

The first DPCM predictor 201 and the second DPCM predictor 202 are formed as shown in FIG. 3.

FIG. 3 shows a predictor stage 300 according to an embodiment of the invention.

A sequence of signal values is input into the predictor stage 300. As an example, the nth signal value x(n) is considered. The nth signal value x(n) is input to a delaying unit 301. The delaying unit 301 outputs signal values preceding the nth signal value x(n). For example, when the predictor stage 300 is of order k, the delaying unit 301 outputs the signal values x(n−k), . . . , x(n−1).

The signal values preceding the nth signal value x(n) are input to an FIR filter unit 302. The FIR filter unit 302 implements an FIR (finite input response) filter. In case of the first DPCM predictor 201 and the second DPCM predictor 202, the FIR filter unit 302 implements a DPCM filter. From the signal values preceding the nth signal value x(n), the FIR filter unit 302 calculates a prediction for the nth signal value x(n), which is denoted by y(n).

The prediction signal value y(n) is substracted from the nth signal value x(n) by a substraction unit 303. The output of the substraction unit 303 is called the nth residual value e(n) which is, together with the prediction signal value y(n), the output of the predictor stage 300.

The predicted signal value y(n) is an approximation of the nth signal value x(n) generated by linearly combining past signal values, i.e., by combining signal values preceding the nth signal value x(n).

In case of the first DPCM predictor 201, the nth signal value x(n) input to the predictor stage 300 is the nth audio sample for the left channel x_{L}(n), the output residual value e(n) is denoted by e_{L,1}(n) and the prediction signal value y(n) is denoted by y_{L,1}(n) (see FIG. 2). e_{L,1}(n) is input into a joint-stereo predictor 203.

Analogously, the second DPCM predictor 202 generates the residual value e_{R,1}(n) from the nth signal value for the right channel x_{R}(n) and the prediction signal value y_{R,1}(n) for the right channel. e_{R,1}(n) is also input into the joint-stereo predictor 203.

The functionality of the joint-stereo predictor 203 is explained with reference to FIG. 4 in the following.

FIG. 4 shows a joint-stereo predictor 400 according to an embodiment of the invention.

The joint-stereo predictor 400 receives as input a signal value for the left channel x_{L}(n), which is the residual value e_{L,1}(n) from FIG. 2 (and not to be mixed up with the nth audio sample for the left channel x_{L}(n) from FIG. 2) and a signal value for the right channel x_{R}(n) which is the residual value e_{R,1}(n) from FIG. 2 (and not to be mixed up with the nth audio sample for the right channel x_{R}(n) from FIG. 2).

The signal value for the left channel x_{L}(n) is input into a first delaying unit 401. The signal value for the right channel x_{R}(n) is input into a second delaying unit 402 and into a third delaying unit 403. As described above, upon input of a signal value, the delaying units 401, 402, 403 output signal values preceding the input signal value.

Therefore, the first delaying unit 401 outputs signal values preceding the signal value x_{L}(n) and these signal values are input into a first FIR filter unit 404.

The number of signal values preceding the signal value for the left channel x_{L}(n) depends on the order of the FIR filter which is implemented by the first FIR filter unit 404. For example, the FIR filter implemented by the first FIR filter unit 404 has order k. So, when the signal value for the left channel x_{L}(n) (which, as mentioned above, corresponds to e_{L,1}(n) in FIG. 2) is input into the first delaying unit 401, the signal values x_{L}(n−k), . . . , x_{L}(n−1) preceding the signal value for the left channel x_{L}(n) are input into the first FIR filter stage 404. (Illustratively, a delaying unit stores the input signal value and outputs it later.) The signal values x_{L}(n−k), . . . , x_{L}(n−1) correspond to the residual values e_{L,1}(n−k), . . . , e_{L,1}(n−k).

Analogously, the second delaying unit 402 outputs signal values preceding the signal value for the right channel x_{R}(n) which are input to a second FIR filter unit 405 and the third delaying unit 403 outputs signal values preceding the signal value for the right channel x_{R}(n) which are input into a fourth FIR filter unit 407 (the number, as mentioned above, depending on the order of the implemented FIR filters). The signal value for the left channel x_{L}(n) is directly, i.e., without delay, input into a third FIR filter unit 406.

The outputs of the first FIR filter unit 404 and the second FIR filter unit 405 are added by a first addition unit 408 which generates a prediction for the left channel y_{L}(n) as a result.

The output of the third FIR filter unit 406 and the output of the fourth FIR filter unit 407 are added by a second addition unit 409 generating as a result the prediction for the right channel y_{R}(n).

The prediction for the left channel y_{L}(n) is substracted by a first substracting unit 410 from the signal value for the left channel y_{L}(n). The output of the first substracting unit 410 is a residual value for the left channel e_{L}(n).

The prediction for the right channel y_{R}(n) is substracted by a second substracting unit 411 from the signal value for the right channel x_{R}(n). The output of the second substracting unit 411 is a residual value for the right channel e_{R}(n).

Illustratively, for the signal value for the left channel x_{L}(n), the prediction for the left channel y_{L}(n) is generated by linearly combining past signal values for both the left channel and the right channel. For the signal value for the right channel x_{R}(n), the prediction y_{R}(n) is generated by linearly combining past signal values from both the left channel and the right channel as well as from the current signal value for the left channel x_{L}(n).

The first filter unit 404, the second filter unit 405, the third filter unit 406 and the fourth filter unit 407 are adaptive filters, the filter weights are adaptively adjusted according to the RLS algorithm (usage of other algorithms, e.g. the LMS algorithm, is also possible). In another embodiment the first filter unit 404, the second filter unit 405, the third filter unit 406 and the fourth filter unit 407 have fixed, for example pre-computed, filter weights.

The output of the joint-stereo predictor 400 is the residual value for the left channel e_{L}(n), denoted by e_{L,2}(n) in FIG. 2, the residual value for the right channel e_{R}(n), denoted by e_{R,2}(n) in FIG. 2, the prediction for the left channel y_{L}(n), denoted by y_{L,2}(n) in FIG. 2 and the prediction for the right channel y_{R}(n), denoted by y_{R,2}(n) in FIG. 2.

e_{L,2}(n) is processed by a first plurality of NLMS predictors 204 comprising K−2 NLMS predictors' numbered with i=3, . . . , K (the index value i=1 corresponds to the first DPCM predictor 201 and the index value i=2 corresponds to the joint-stereo predictor 203, see FIG. 2).

Each NLMS predictor of the first plurality of NLMS predictors 204 is adapted as shown in FIG. 3, wherein the FIR filter unit 302 in this case implements an FIR filter according to the NLMS (Normalized least mean squares) algorithm. Each NLMS predictor of the plurality of NLMS predictors 204 outputs a prediction value, which is, for the NLMS predictor with index of the first plurality of NLMS predictors 204 denoted by y_{L,i}(n), and a residual value, which is, for the NLMS predictor with index i of the plurality of NLMS predictors 204, denoted by e_{L,i}(n).

Analogously, e_{R,2}(n) is processed by a second plurality of NLMS predictors 205, each NLMS predictor of the plurality of NLMS predictors 205 outputting a residual value (analogously to above denoted by e_{R,i}(n), i=3, . . . , K) and a prediction value (analogously to above denoted by y_{R,i}(n), i=3, . . . , K).

All prediction values y_{L,i}(n) (for i=1, . . . , K) are processed by a first linear combiner 206. The first linear combiner 206 multiplies each prediction value Y_{L,i}(n) with a weight c_{L,i}.

The weights C_{L,i} (i=1, . . . , K) of the first linear combiner 206 are adaptively adjusted according to the Sign-Sign LMS algorithm in course of the encoding process.

The Sign-Sign LMS is used to adjust the linear combiner weights c_{L,i} (i=1, . . . , K) because of its simplicity. It shows good performance in practice. However, other types of adaptive algorithms can also be used. As well, some of the linear combiner weights c_{L,i} (i=1, . . . , K) can be set as constants. In experiments it is found that setting the first two linear combiner weights to 1.0 gives the best overall results.

The results from all these multiplications performed by the first linear combiner 206 are added by the first linear combiner 206 to form a prediction value y_{L}(n) which is quantised by a first quantizer 207 and substracted from the audio sample for the left channel x_{L}(n) to produce a residual ê_{L}(n) for the left channel.

Analogously, a second linear combiner 208 generates a prediction value yᵣ(n) for the right channel, which is quantised by the second quantizer 209 and substracted from the audio sample for the right channel x_{R}(n) such that the residual ê_{R}(n) for the right channel is generated.

The first quantizer 207 and the second quantizer 209 perform a quantisation to integer values. The residual for the left channel and the residual for the right channel are integers.

When the encoded audio signal 102 has been generated as explained with reference to FIG. 1, the encoded audio signal 102 can be transmitted to a decoder corresponding to the encoder 100 for decoding the encoded audio signal 102 and losslessly reconstructing the original audio signal 101. The decoder is formed analogously to the encoder 100. In particular, the decoder comprises a predictor similar to the predictor 200. The main difference is, since the predictor of the decoder receives a residual value as input, that the corresponding prediction value is calculated from signal values of the original audio signal 101 which already have been reconstructed and is added to the residual value to from the reconstructed signal value corresponding to the residual value.

In one embodiment, the joint-stereo-prediction according to FIG. 2 is integrated into an MPEG-4 ALS RM8 (Audio lossless only coding reference module 8) audio coder using floating-point C. In this embodiment, the lossless compression ration can be improved with respect to ordinary MPEG-4 ALS RM8 by 1.56%, which a significant improvement. Further, with this embodiment, an improvement of 0.1% with respect to the OFR (OptimFROG) audio coder can be achieved.

The embodiments described above concern the two-channel case for easy illustration. The techniques presented in this patent can be extended to the multi-channel case in a straightforward way. In the multi-channel case with N channels (and corresponding digital signals), the inter channel prediction for a channel (i.e. for the digital signal representative for the channel) is the summation of an inter-channel prediction (made from the other N−1 channels, i.e. from the respective digital signals) and the intra-channel prediction (made from the channel).

In this document, the following publications are cited:
[1] Rongshan Yu, Chi Chung Ko “Lossless Compression of Digital Audio Using Cascaded RLS-LMS Prediction”, IEEE TRANSACTIONS ON SPEECH AND AUDIO PROCESSING, VOL. 11, NO. 6, pp. 532-537 November 2003
[2] Gerald D. T. Schuller, et al. “Perceptual Audio Coding Using Adaptive Pre- and Post-Filters and Lossless Compression”, IEEE TRANSACTIONS ON SPEECH AND AUDIO PROCESSING, VOL. 10, NO. 6, pp. 379-390, September 2002
[3] Florin Ghido “An Asymptotically Optimal Predictor for Stereo Lossless Audio Compression”, PROCEEDINGS OF THE DATA COMPRESSION CONFERENCE, 2003

### REFERENCE SIGNS

101 original audio signal
102 encoded audio signal
103 predictor
104 residual signal
105 entropy coder
106 multiplexer
200 predictor
201,202 DPCM predictors
203 joint-stereo predictor
204,205 NLMS predictors
206 linear combiner
207 quantizer
208 linear combiner
209 quantizer
300 predictor stage
301 delaying unit
302 FIR filter unit
303 substraction unit
400 joint-stereo predictor
401-403 delaying units
404-407 FIR filter units
408,409 addition units
410,411 substracting units

1. Encoder for encoding a first digital signal representative for a first channel and a second digital signal representative for a second channel, the encoder comprising
a first intra-channel prediction element processing the first digital signal, thereby providing a first residual signal for the first channel;
a second intra-channel prediction element processing the second digital signal, thereby providing a first residual signal for the second channel;
an inter-channel prediction element processing the first residual signal for the first channel and the first residual signal for the second channel by linearly combining the first residual signal for the first channel and the first residual signal for the second channel, thereby providing a second residual signal for the first channel and a second residual signal for the second channel.

2. Encoder according to claim 1, further comprising
a third intra-channel prediction element processing the second residual signal for the first channel, thereby providing a third residual signal for the first channel;
a fourth intra-channel prediction element processing the second residual signal for the second channel, thereby providing a third residual signal for the second channel.

3. Encoder according to claim 2, wherein the first intra-channel prediction element further provides a first prediction signal for the first channel, the second intra-channel prediction element further provides a first prediction signal for the second channel, the inter-channel prediction element further provides a second prediction signal for the first channel and a second prediction signal for the second channel, the third intra-channel prediction element further provides a third prediction signal for the first channel and the fourth intra-channel prediction element further provides a third prediction signal for the second channel.

4. Encoder according to claim 2, further comprising a first cascade of intra-channel prediction elements, wherein the first intra-channel prediction element of the first cascade of intra-channel prediction elements provides a further residual signal for the first channel and a further prediction signal for the first channel by processing the third residual signal for the first channel and each of the other intra-channel prediction elements of the first cascade of intra-channel prediction elements provides a further residual signal for the first channel and a further prediction signal for the first channel by processing the further residual signal for the first channel provided by the preceding intra-channel prediction element of the first cascade of intra-channel prediction elements.

5. Encoder according to claim 4, further comprising a second cascade of intra-channel prediction elements, wherein the first intra-channel prediction element of the second cascade of intra-channel prediction elements provides a further residual signal for the second channel and a further prediction signal for the second channel by processing the third residual signal for the second channel and each of the other intra-channel prediction elements of the second cascade of intra-channel prediction elements provides a further residual signal for the second channel and a further prediction signal for the second channel by processing the further residual signal for the second channel provided by the preceding intra-channel prediction element of the second cascade of intra-channel prediction elements.

6. Encoder according to claim 4, further comprising a first linear combiner linearly combining at least two of the first residual signal for the first channel, the second residual signal for the first channel, the third residual signal for the first channel and the further residual signals for the first channel, thereby providing a final prediction signal for the first channel.

7. Encoder according to claim 6, further comprising a first substracting unit substracting the quantized final prediction signal for the first channel from the first digital signal.

8. (canceled)

9. Encoder according to claim 6, wherein the first linear combiner is adapted such that first linear combiner weights are adjusted according to the Sign-Sign LMS algorithm in course of the encoding process.

10. Encoder according to claim 5, further comprising a second linear combiner linearly combining at least two of the first residual signal for the second channel, the second residual signal for the second channel, the third residual signal for the second channel and the further residual signals for the second channel, thereby providing a final prediction signal for the second channel.

11. Encoder according to claim 10, further comprising a second substracting unit substracting the quantized final prediction signal for the second channel from the second digital signal.

12. (canceled)

13. Encoder according to claim 10, wherein the second linear combiner is adapted such that second linear combiner weights are adjusted according to the Sign-Sign LMS algorithm in course of the encoding process.

14. Encoder according to claim 1, wherein the first intra-channel prediction element and/or the second intra-channel prediction element comprises an FIR filter unit.

15. Encoder according to claim 1, wherein the inter-channel prediction element comprises a plurality of adaptive FIR filter units.

16. Encoder according to claim 5, wherein the third intra-channel prediction element and/or the fourth intra-channel prediction element and/or the intra-channel prediction elements of the first cascade of intra-channel prediction elements and/or the intra-channel prediction elements of the second cascade of intra-channel prediction elements comprise adaptive FIR filter units.

17. Encoder according to claim 1, wherein the first digital signal and the second digital signal are digitized audio signals.

18. Encoder according to claim 1, adapted to further encode a third or more digital signals representative for a third or more channels.

19. Method for encoding a first digital signal representative for a first channel and a second digital signal representative for a second channel comprising the steps
processing the first digital signal, thereby providing a first residual signal for the first channel;
processing the second digital signal, thereby providing a first residual signal for the second channel;
processing the first residual signal for the first channel and the first residual signal for the second channel by linearly combining the first residual signal for the first channel and the first residual signal for the second channel, thereby providing a second residual signal for the first channel and a second residual signal for the second channel.

20. Decoder for decoding an encoded first digital signal representative for a first channel and an encoded second digital signal representative for a second channel, the decoder comprising
a first intra-channel prediction element processing the encoded first digital signal, thereby providing a first residual signal for the first channel;
a second intra-channel prediction element processing the encoded second digital signal, thereby providing a first residual signal for the second channel;
an inter-channel prediction element processing the first residual signal for the first channel and the first residual signal for the second channel by linearly combining the first residual signal for the first channel and the first residual signal for the second channel, thereby providing a second residual signal for the first channel and a second residual signal for the second channel.

21. Method for decoding a first digital signal representative for a first channel and a second digital signal representative for a second channel comprising the steps
processing the encoded first digital signal, thereby providing a first residual signal for the first channel;
processing the encoded second digital signal, thereby providing a first residual signal for the second channel;
processing the first residual signal for the first channel and the first residual signal for the second channel by linearly combining the first residual signal for the first channel and the first residual signal for the second channel, thereby providing a second residual signal for the first channel and a second residual signal for the second channel.

22. A computer readable medium having a program recorded thereon, wherein the program is adapted to make a computer perform a method for encoding a first digital signal representative for a first channel and a second digital signal representative for a second channel comprising the steps
processing the first digital signal, thereby providing a first residual signal for the first channel;
processing the second digital signal, thereby providing a first residual signal for the second channel;
processing the first residual signal for the first channel and the first residual signal for the second channel by linearly combining the first residual signal for the first channel and the first residual signal for the second channel, thereby providing a second residual signal for the first channel and a second residual signal for the second channel.

23. A computer readable medium having a program recorded thereon, wherein the program is adapted to make a computer perform a method for decoding a first digital signal representative for a first channel and a second digital signal representative for a second channel comprising the steps
processing the encoded first digital signal, thereby providing a first residual signal for the first channel;
processing the encoded second digital signal, thereby providing a first residual signal for the second channel;
processing the first residual signal for the first channel and the first residual signal for the second channel by linearly combining the first residual signal for the first channel and the first residual signal for the second channel, thereby providing a second residual signal for the first channel and a second residual signal for the second channel.

24. A computer program element, which, when executed by a computer, makes the computer perform a method for encoding a first digital signal representative for a first channel and a second digital signal representative for a second channel comprising the steps
processing the first digital signal, thereby providing a first residual signal for the first channel;
processing the second digital signal, thereby providing a first residual signal for the second channel;
processing the first residual signal for the first channel and the first residual signal for the second channel by linearly combining the first residual signal for the first channel and the first residual signal for the second channel, thereby providing a second residual signal for the first channel and a second residual signal for the second channel.

25. A computer program element, which, when executed by a computer, makes the computer perform a method for decoding a first digital signal representative for a first channel and a second digital signal representative for second channel comprising the steps
processing the encoded first digital signal, thereby providing a first residual signal for the first channel;
processing the encoded second digital signal, thereby providing a first residual signal for the second channel;
processing the first residual signal for the first channel and the first residual signal for the second channel by linearly combining the first residual signal for the first channel and the first residual signal for the second channel, thereby providing a second residual signal for the first channel and a second residual signal for the second channel.
